(19) United States
(12) Patent Application Publication
(10) Pub. No.: US 2009/0231628 A1
(43) Pub. Date: Sep. 17, 2009

(54) Image Processing Apparatus, Image Processing Method, Computer Program for Image Processing

(75) Inventor: Masatoshi Matsuhira, Matsumoto-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/402,347

(22) Filed: Mar. 11, 2009

(30) Foreign Application Priority Data
Mar. 14, 2008 (JP) 2008-066229

(51) Int. Cl. G06K 15/00; G06K 9/46

(52) U.S. Cl. 358/1.18; 382/195

(57) ABSTRACT

An image processing apparatus. A size relationship determining unit determines a size relationship between a size in a target image and an actual size. A face area detecting unit detects a face area of the target image that includes at least a partial image of a face of a person. The face area detecting unit determines a range of a control parameter correlated with the size in the target image from a predetermined range of the actual size in accordance with the size relationship, and detects the face area in accordance with the control parameter within the determined range.

### CROSS-REFERENCE TO RELATED APPLICATIONS

This application claims the benefit of priority under 35 USC 119 of Japanese application no. 2008-066229, filed on Mar. 14, 2008, which is incorporated herein by reference.

### BACKGROUND

1. Technical Field

The present invention relates to an image processing apparatus and method, and a computer program for image processing.

2. Related Art

Various types of image processing are generally known and used. For example, there are processes of correcting colors and of deforming a subject. Image processing is not limited to image correction, and includes processes in which the image is not modified, such as processes of outputting (including printing and display processes) or classifying images.

In order to perform the image processing, technology for detecting a person's face from an image is often used. Related art in this regard is disclosed in JP-A-2004-318204. However, there are various types of subjects copied into an image that represents a person's face. For example, there are a child and an adult. In addition, there are various types of subjects that are similar to a person's face. For example, there are a doll, a poster representing a person's face, and the like. Sufficient study for detecting a face in consideration of the type of the subject has not been made in the related art.

### SUMMARY

The invention provides an image processing apparatus, method, and computer program that detect a face in consideration of the type of subject. The invention may be implemented in the following forms or exemplary embodiments.

According to an aspect of the invention, an image processing apparatus is provided including: a size relationship determining unit that determines a size relationship between a size in a target image and an actual size; and a face area detecting unit that detects a face area of the target image that includes at least a partial image of a face of a person. The face area detecting unit determines a range of a control parameter correlated with the size in the target image from a predetermined range of the actual size in accordance with the size relationship, and detects the face area in accordance with the control parameter within the determined range.

With such a configuration, since the face area is detected in accordance with the control parameter within the range determined in accordance with the size relationship from the predetermined range of the actual size, the face is detected in consideration of the kinds of subject.

In one embodiment of the image processing apparatus, the face area detecting unit shows at least a part of the face and detects the face area by using at least one of an image pattern of a size that is in correspondence with the control parameter and a detection window, which is used to select a detection target area from the target image, of a size that is in correspondence with the control parameter.

With such a configuration, since the face area is detected by using at least one the image pattern of the size that is in correspondence with the control parameter and the detection window, the face is detected in consideration of the types of subject.

In another embodiment of the image processing apparatus, the control parameter represents a scaling ratio for scaling the target image. In addition, the face area detecting unit generates a scaled image by scaling the target image in accordance with the scaling ratio and detects the face area by using the scaled image and at least one of an image pattern of a predetermined size representing at least a part of the face and a detection window of a predetermined size being used to select a detection target area from the scaled image.

With such a configuration, since the scaled image is generated by scaling the target image in accordance with the scaling ratio and the face area is detected by using the scaled image and at least one of the image pattern of the predetermined size and the detection window of the predetermined size, the face is detected in consideration of the types of subject.

Another embodiment of the image processing apparatus further includes: an image pickup unit that generates image data by performing an image pickup operation; and a process performing unit that performs a determination process in accordance with a match of an image pattern represented by the face area with a predetermined pattern. The image pickup unit sequentially generates the image data by repeating the image pickup operation. In addition, the size relationship determining unit and the face area detecting unit sequentially determine the size relationship and detect the face area by using each image represented by the image data, which is sequentially generated.

With such a configuration, the face is detected in consideration of the types of subject, when the determination process is performed in accordance with the image pattern of the face area.

In another embodiment of the image processing apparatus, the determination process includes a process of performing an image pickup operation on an image including the face area that matches the predetermined pattern.

With such a configuration, the face is detected in consideration of the types of subject in order to perform the image pickup operation for the image including the face area that matches the predetermined pattern.

In another embodiment of the image processing apparatus, the target image is an image that is generated by an image pickup device. The size relationship determining unit determines the size relationship by using related information that is related with the target image. The related information includes: image pickup distance information that is related with a distance from the image pickup device to the person upon performing the image pickup operation on the target image; focal distance information that is related with a lens focal distance of the image pickup device upon performing the image pickup operation; and image pickup element information that is related with a size of a part of a light receiving area of the image pickup element of the image pickup device in which the target image is generated.

With such a configuration, the size relationship is determined appropriately by using the related information. As a result, the face is detected in appropriate consideration of the types of subject.

According to another aspect of the invention, a printer is provided including: a size relationship determining unit that determines a size relationship between a size in a target image and an actual size; a face area detecting unit that detects a face area of the target image that includes at least a partial image of a face of a person; an image processing unit that performs a determination process on the target image in accordance with the detected face area; and a printing unit that prints the target image processed by the image processing unit. The face area detecting unit determines a range of a control parameter correlated with the size in the target image from a predetermined range of the actual size in accordance with the size relationship, and detects the face area in accordance with the control parameter within the determined range.

Another aspect of the invention is an image processing method including: determining a size relationship between a size in a target image and an actual size; and detecting a face area of the target image that includes at least a partial image of a face of a person. The detecting of the face area includes determining a range of a control parameter correlated with the size in the target image from a predetermined range of the actual size in accordance with the size relationship and detecting the face area in accordance with the control parameter within the determined range.

Another aspect of the invention is a computer program embodied on a computer-readable medium for image processing. The computer program causes a computer to execute: a size relationship determining function of determining a size relationship between a size in a target image and an actual size; and a face area detecting function of detecting a face area of the target image that includes at least a partial image of a face of a person. The face area detecting function includes a function of determining a range of a control parameter correlated with the size in the target image from a predetermined range of the actual size in accordance with the size relationship, and a function of detecting the face area in accordance with the control parameter within the determined range.

The invention may be implemented in various forms such as an image processing method, an image processing apparatus, a computer program for implementing the functions of the image processing method or apparatus, and a recording medium having the computer program recorded thereon.

### BRIEF DESCRIPTION OF THE DRAWINGS

The invention will be described with reference to the accompanying drawings, wherein like numbers reference like elements.

FIG. 1 is a block diagram of a printer according to an embodiment of the invention.

FIG. 2 is a block diagram showing modules and data that are stored into a ROM according to an embodiment of the invention.

FIG. 3 is a schematic diagram including a model size table according to an embodiment of the invention.

FIG. 4 is a flowchart of a printing process according to an embodiment of the invention.

FIG. 5 is an explanatory diagram showing the relationship between the number of pixels of an image and the actual size according to an embodiment of the invention.

FIG. 6 is a schematic diagram showing a search range according to an embodiment of the invention.

FIG. 7 is a schematic diagram of a process of searching a face area according to a second embodiment of the invention.

FIG. 8 is a schematic diagram of a process of searching a face area according to a third embodiment of the invention.

FIG. 9 is a schematic diagram of a process of searching a face area according to a fourth embodiment of the invention.

FIG. 10 is a block diagram showing modules and data that are stored in a ROM according to a fifth embodiment of the invention.

FIG. 11 is a flowchart of a printing process according to the fifth embodiment.

FIG. 12 is a schematic diagram showing a result of detection of candidates of a face area according to the fifth embodiment.

FIG. 13 is a block diagram of a digital still camera according to a sixth embodiment of the invention.

FIG. 14 is a block diagram showing modules and data that are stored in a ROM according to the sixth embodiment.

FIG. 15 is a schematic diagram representing the determination process of the image data according to the sixth embodiment.

### DESCRIPTION OF EXEMPLARY EMBODIMENTS

Embodiments of the invention are described herein in the following order.

First Embodiment

Second Embodiment

Third Embodiment

Fourth Embodiment

Fifth Embodiment

Sixth Embodiment

Modified Examples

### First Embodiment

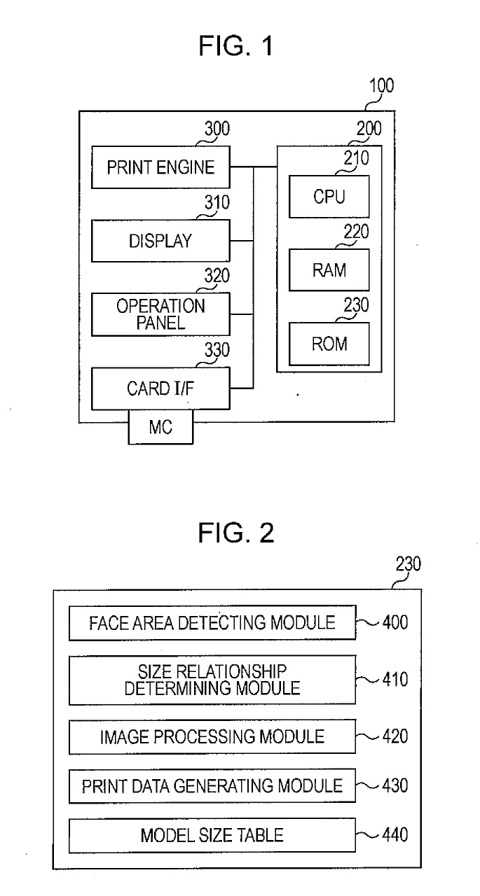

FIG. 1 is a block diagram of a printer 100 according to an embodiment of the invention. Printer 100 includes a control unit 200, a print engine 300, a display 310, an operation panel 320, and a card interface (I/F) 330.

The control unit 200 is a computer that includes a CPU 210, a RAM 220, and a ROM 230. Control unit 200 controls constituent elements of the printer 100.

The print engine 300 is a printing mechanism that performs a printing process by using supplied print data. Various printing mechanisms such as a printing mechanism that forms an image by discharging ink droplets onto a printing medium and a printing mechanism that forms an image by transferring and fixing toner on a printing medium may be employed.

The display 310 displays various types of information including an operation menu and an image in accordance with an instruction transmitted from the control unit 200. Various displays such as liquid crystal and organic EL displays may be employed.

The operation panel 320 receives a direction from a user. The operation panel 320 may include, for example, operation buttons, a dial, or a touch panel.

The card I/F 330 is an interface of a memory card MC. The control unit 200 reads out an image file that is stored in the memory card MC through the card I/F 330. Then, the control unit 200 performs a printing process by using the read-out image file.

FIG. 2 is a block diagram showing modules and data that are stored into the ROM 230 (FIG. 1). According to this embodiment, a face area detecting module 400, a size relationship determining module 410, an image processing module 420, a printing data generating module 430, and a model size table 440 are stored in the ROM 230. Modules 400-430 may be programs that are executed by the CPU 210. The modules 400-430 can transmit or receive data to or from one another through the RAM 220. The functions of the modules 400-430 will be described later in detail.

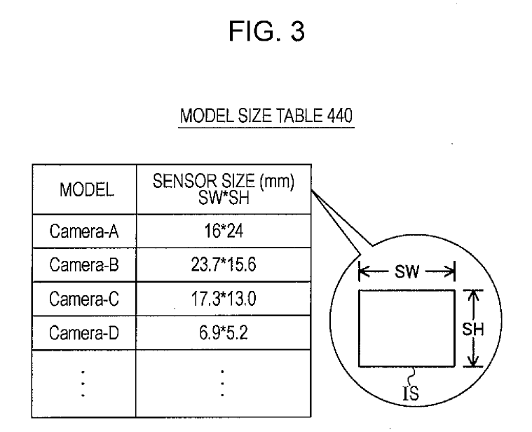

FIG. 3 is a schematic diagram showing an example of the model size table 440. The model size table 440 stores a correspondence relationship between a model of an image generating device (for example, a digital still camera) and the size of an image pickup element (also referred to as “a light receiving device” or “an image sensor”) of the model therein. In this embodiment, it is assumed that the shape of a light receiving area of an image pickup element is rectangular. In addition, as the size of an image pickup element, the height SH (the length of a shorter side) and the width SW (the length of a longer side) of the light receiving area (the rectangular shape) are used. As described above, the sizes of the image pickup element are determined in advance for the models of the image generating devices. Thus, each model is related to the size of the light receiving area of the image pickup element thereof (the model in this embodiment corresponds to “image pickup element information” in the claims).

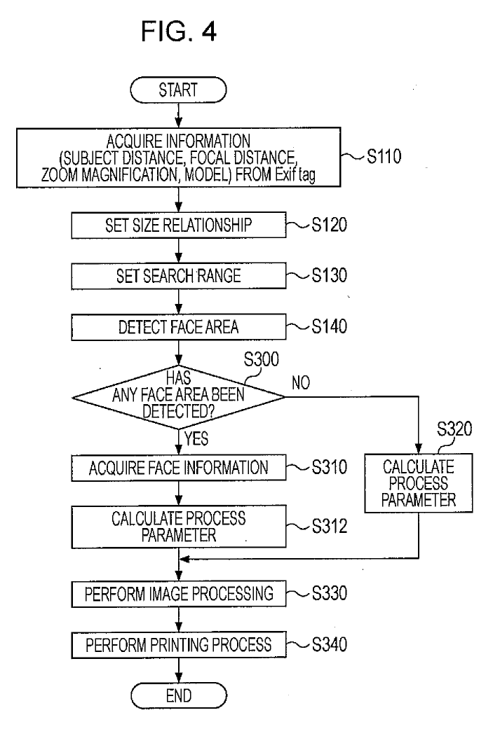

FIG. 4 is a flowchart of the printing process. The control unit 200 (FIG. 1) starts this printing process in accordance with a user's direction that is input to the operation panel 320. In this printing process, the control unit 200 prints an image that is represented by the image data included in the image file that is designated by the user's direction. Hereinafter, the image file that is designated by the user is referred to as a “target image file”, the image data that is stored in the target image file is referred to as “target image data”, and the image that is represented by the target image data is also referred to as a “target image”.

In Step S110, the size relationship determining module 410 acquires related information from the target image file. In this embodiment, the image pickup device (for example, a digital still camera) generates an image file in conformity with, for example, the Exif (Exchangeable Image File Format) standards. The image file includes additional information, such as the model of the image pickup device and a lens focal distance for image pickup in addition to image data, that is related to the target image data.

According to this embodiment, the size relationship determining module 410 acquires the following information from the target image file.

1) subject distance

2) lens focal distance

3) digital zoom magnification

4) model name

The subject distance represents a distance between the image pickup device and a subject upon performing an image pickup process. The lens focal distance represents a lens focal distance upon performing the image pickup process. The digital zoom magnification represents the magnification ratio of a digital zoom upon performing the image pickup process. Generally, digital zoom is a process in which a peripheral part of the image data is cropped and pixel interpolation is performed for the remaining image data to form the original pixel number. Such information represents settings of operations of the image pickup device upon performing the image pickup process. The model name represents the model of the image pickup device. A typical image pickup device generates image data by performing an image pickup process and generates an image file that includes the image data and the additional information.

In Step S120, the size relationship determining module 410 determines (sets) the size relationship. The size relationship represents a correspondence relationship between the size of the target image (also referred to as the size in the target image; for example, a length) and the actual size.

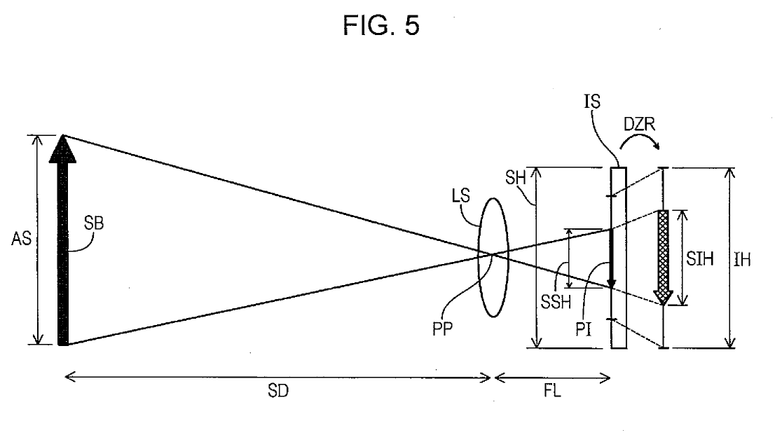

FIG. 5 is an explanatory diagram showing the relationship between the number of pixels of an image and the actual size. FIG. 5 is a side view showing the positional relationship of a subject SB, a lens system LS, and an image pickup element IS. The lens system LS includes a plurality of lenses. In FIG. 5, for simplification, one lens represents the lens system LS. The following elements are shown in FIG. 5: the actual size AS (actual length) of the subject, a subject distance SD, a lens focal distance FL, the length (the height SH) of the image pickup element IS, a formed image PI that represents the subject SB formed on a light receiving face (imaging face) of the image pickup element IS, the size (the number SSH of pixels in the height direction) of the formed image PI, the digital zoom magnification DZR, the size (a total number IH of the pixels in the height direction) of the image, and the size (the number SIH of pixels in the height direction) of the subject on the image.

In addition, the actual size AS of the subject SB represents a length in the height direction (corresponding to the height direction of the image pickup element IS). The subject distance SD acquired in Step S110 is almost the same as a distance between the optical center (principal point PP) of the lens system LS and the subject SB. The lens focal distance FL represents a distance between the optical center (principal point PP) of the lens system LS and the imaging face of the image pickup element IS.

As is well known, a triangle defined by the principal point PP and the subject SB is similar to a triangle defined by the principal point PP and the formed image PI. Accordingly, the following relationship equation of Expression 1 is satisfied:

AS:SD=SSH:FL (1).

Here, it is assumed that the parameters AS, SD, SSH, and FL are represented in a same unit (for example, “cm”). The principal point of the lens system LS that is viewed from the subject SB side may be different from that of the lens system LS that is viewed from the formed image PI side. However, in FIG. 5, since a difference therebetween is sufficiently small, the difference is not shown.

The size SIH of the subject in the image is the same as a value obtained from multiplying the size SSH of the formed image PI by the digital zoom magnification DZR (SIH=SSH×DZR). The size SIH of the subject in the image is actually represented by the number of pixels. The height SH of the image pickup element IS corresponds to the total number IH of pixels. Accordingly, the size SSH of the formed image PI is represented in millimeter unit by the following equation of Expression 2 by using the number SIH of pixels:

SSH=(SIH×SH/IH)/DZR (2).

Here, it is assumed that the height SH of the image pickup element IS is represented in millimeter unit.

From Expressions 1 or 2, the actual size AS of the subject SB is represented by the following equation of Expression 3:

AS=(SD×100)×((SIH×SH/IH)/DZR)/FL (3).

Here, it is assumed that the units of the parameters are set as below. The actual size AS of the subject SB is represented in “cm” unit, the subject distance SD is represented in “m” unit, the height SH of the image pickup element IS is represented in “mm” unit, and the lens focal distance FL is represented in “mm” unit.

The size relationship determining module 410 sets the size relationship in accordance with Expression 3. As described above, according to this embodiment, the size relationship represents a ratio of lengths.

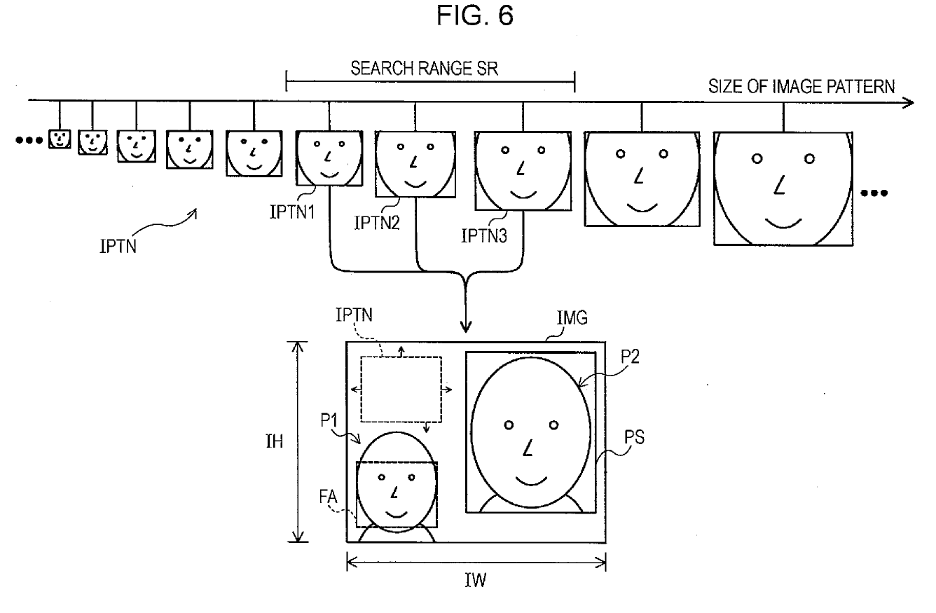

In Step S130, the face area detecting module 400 (FIG. 2) sets a search range in accordance with the size relationship. FIG. 6 is a schematic diagram showing the search range SR according to this embodiment. In FIG. 6, a plurality of image patterns IPTN is shown. Each image pattern IPTN shows a rectangular shape that includes an image of two eyes, a nose, and a mouth of a person. The image patterns IPTN are similar but different from each other in size (for example, height). According to this embodiment, the face area detecting module 400 detects an area of the target image IMG that matches the image pattern IPTN as a face area. When a large image pattern IPTN is used, a face included in the target image which has a large size can be detected. On the other hand, when a small image pattern IPTN is used, a face in the target image which has a small size can be detected.

The face area detecting module 400 determines the size range (the search range SR) of the image pattern IPTN in accordance with the size relationship. According to this embodiment, the aspect ratio of the image pattern IPTN is constant regardless of the size thereof. Accordingly, the search range SR may be regarded to represent the height range or the width range of the image pattern IPTN.

The search range SR is determined such that the range of the actual size corresponding to the search range SR is a predetermined range appropriate to the face of a person. A range of 5 cm to 50 cm may be employed as the appropriate range of the actual size, for example. The face area detecting module 400 determines the range of the size SIH (the number of pixels) in the target image by applying this range of the actual size as the actual size AS (FIG. 5) included in Expression 3. The determined range becomes the search range SR. The face area detecting module 400 can detect a face of which the actual size (the size corresponding to the height of the face area) is within the range of 5 cm to 50 cm by using the image pattern IPTN that is within the search range SR. As a result, detection of an excessively small face (for example, the face of a doll) or an excessively large face (for example, a face copied in a poster) is suppressed. In addition, the predetermined range that is appropriate to a face of a person may be a range other than the range of 5 cm to 50 cm, and is preferably determined experimentally in advance.

In Step S140, the face area detecting module 400 detects a face area by using the image pattern IPTN that is in correspondence with the image pattern size within the search range SR. In the embodiment of FIG. 6, three image patterns IPTN1, IPTN2, and IPTN3 that are different in a size are used. The face area represents an area of the target image in which an image of at least a part of a face is included.

In FIG. 6, the result of detection of a face area from the target image IMG is shown. In this embodiment, the shape of the target image is rectangular. The image height IH and the image width IW represent the height (the length of a shorter side) of the target image and the width (the length of a longer side) of the target image (in a unit of the numbers of pixels). The face area detecting module 400 detects face areas located in various positions within the target image IMG by moving the image pattern IPTN within the target image IMG. When one target image represents a plurality of faces, the face area detecting module 400 detects a plurality of face areas.

In the target image IMG shown in FIG. 6, a person P1 and a poster PS are copied. The poster PS represents a person P2. Here, the actual size of the face of the person P2 shown in the poster PS is sufficiently larger than the size of the face of the actual person. As a result, the face area detecting module 400 detects the face area FA that represents the face of the person P1. However, the area that represents the face of the person P2 within the poster PS is not detected as a face area.

The face area detecting module 400 uses a plurality of image patterns that are prepared in advance as the plurality of image patterns IPTN. The face area detecting module 400 may generate a plurality of image patterns having different sizes by appropriately scaling one image pattern IPTN. In any case, the interval of the image patterns IPTN is preferably experimentally determined in advance to appropriately detect faces of persons that have various sizes.

In Step S300, the image processing module 420 determines whether a face area has been detected. When the face area has been detected, the image processing module 420 performs image processing of Steps S310, S312, and S330 for the face of a person. Various processes can be employed as the processing for the person's image. For example, a process of correcting the color of the face (particularly, the skin) may be employed. As the color correcting process, for example, a process of enhancing the brightness of a skin color or a process of approximating the skin color to a predetermined color may be employed. Instead of the color correcting process, a deformation process of decreasing the width of a face may be employed. In any case, in Step S310, the face processing module 420 acquires information on the detected face (for example, the average color and average luminance of pixels representing the skin of the face and the width (the number of pixels) of the face)). In Step S312, the image processing module 420 calculates parameters of the image processing by using the acquired information (for example, the adjustment amounts of color and brightness and the deformation amount of the width of the face). In Step S330, the image processing module 420 performs image processing in accordance with the parameters of the image processing.

On the other hand, when any face area has not been detected, the image processing module 420 (FIG. 2) performs standard image processing in Steps S320 and S330. Various processes may be employed as the standard image processing. For example, processes of adjusting the white balance of the target image or of approximating the average brightness within the target image to a predetermined brightness may be performed. In any case, in Step S320, the image processing module 420 calculates the parameters of the image processing by using the target image (for example, the adjustment amount of white balance and a tone curve for adjusting brightness). In Step S330, the image processing module 420 performs the image processing in accordance with the parameters of the image processing.

In Step S340, the print data generating module 430 generates print data by using image data that has been processed by the image processing module 420. Any format of the print data that is appropriate to the print engine 300 may be employed. For example, according to this embodiment, the print data generating module 430 generates the print data that represents record states of each ink dot by performing a resolution converting process, a color converting process, and a halftone process. Then, the print data generating module 430 supplies the generated print data to the print engine 300. The print engine 300 performs a printing process based on the received print data. Then, the process shown in FIG. 4 is completed. The print data generating module 430 and the print engine 300 collectively correspond to “a printing unit” of the claims.

As described above, according to this embodiment, the search range SR of the size of the image pattern IPTN is determined based on the predetermined range of the actual size in accordance with the size relationship. Accordingly, the actual size that can be acquired from the size within the search range SR in accordance with the size relationship is within the predetermined range. Here, the size (for example, the height) of the image pattern IPTN represents the size of a rectangle that includes two eyes and a mouth. In other words, the size of the image pattern IPTN represents the size in the target image that reflects the size of a face. Accordingly, detection of an area representing an excessively large face (for example, an area that represents a face copied in a poster) or an area representing an excessively small face (for example, an area that represents the face of a doll) as a face area is suppressed. In other words, the face area is detected by distinguishing a subject representing a face of an actual size that is appropriate as a person from a subject representing a face of an actual size that is excessively small or excessively large. As described above, the face is detected in consideration of the type of subject. In particular, the face area detecting module 400 does not detect any face area in accordance with an image pattern IPTN having a size beyond the search range SR. Accordingly, the face area detecting module 400 can perform detection of the face area at a high speed. The face area detecting module 400 may determine the search range SR based on various values relating to the size of the image pattern IPTN, instead of the size of the image pattern IPTN.

### Second Embodiment

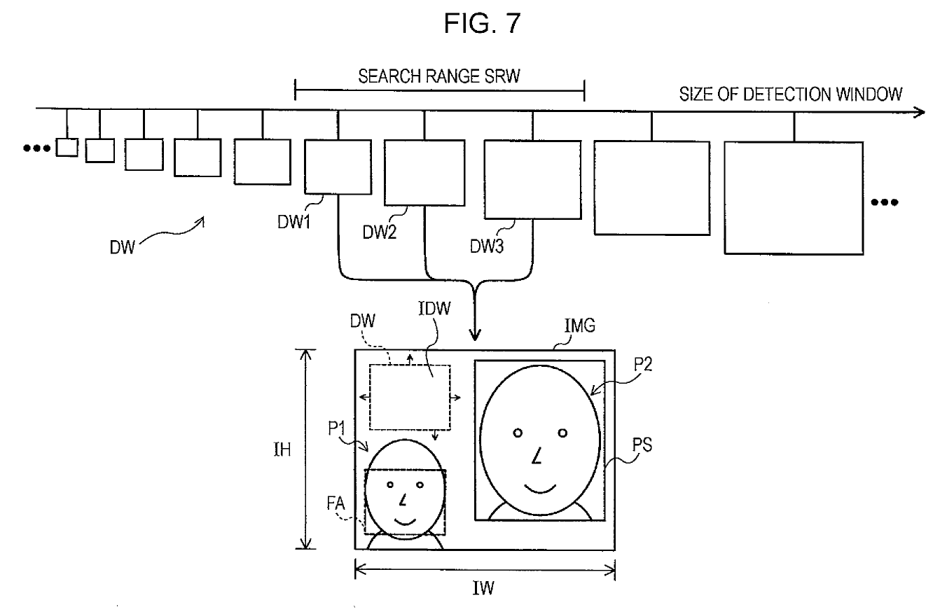

FIG. 7 is a schematic diagram of a process of searching a face area according to a second embodiment of the invention. The first embodiment of FIG. 6 and the second embodiment of FIG. 7 differ in that, in the second embodiment, a detection window DW is used instead of the image pattern IPTN. The sequence of the printing process is the same as that in FIG. 4. However, the two Steps S130 and S140 are different from those of the first embodiment. The other steps are the same as those of the first embodiment. In addition, the configuration of a printer is the same as that of the printer 100, which is shown in FIGS. 1 and 2, according to the first embodiment.

According to the second embodiment, a face area detecting module 400 detects a face area by using a learning-completed neural network, instead of pattern matching. Here, the face area detecting module 400 determines a detection target area IDW within a target image IMG by using the detection window DW (the target area IDW is an area inside the detection window DW). The face area detecting module 400 determines whether the target area IDW is a face area by using pixel values of the target area IDW. This determination is performed in accordance with the neural network. According to this embodiment, the neural network is built such that a target area IDW is determined to be a face area for a case where the target area IDW includes images of two eyes, a nose, and a mouth. The face area detecting module 400 detects face areas located in various positions within the target image IMG by moving the detection window DW within the target image IMG. In this embodiment, the shape of the detection window DW is rectangular.

In FIG. 7, a plurality of the detection windows DW having different sizes are shown. The detection windows DW are similar to each other, and the sizes (for example, the heights) of the detection windows DW are different from one another. According to this embodiment, the face area detecting module 400 detects a face area based on relative positions within the detection window DW. In other words, when a small detection window DW is used, a small face is detected. On the other hand, when a large detection window DW is used, a large face is detected. As described above, the size of the detection window DW is related with the size of a detected face (that is, a face area) in the target image. As the size of the detection window DW becomes larger, the face area detecting module 400 detects a face area representing a larger face.

In Step S130 of FIG. 4, the face area detecting module 400 determines the range (the search range SRW) of the size of the detection window DW in accordance with the size relationship. According to this embodiment, the aspect ratio of the detection window DW is constant regardless of the size thereof. Accordingly, the search range SRW can be regarded to represent the range of the height or the width of the detection window DW. In addition, determination on the search range SRW is performed in the same manner as in determination on the search range SR according to the first embodiment of FIG. 6. In other words, the search range SRW is determined such that the range of the actual size corresponding to the search range SRW is a predetermined range appropriate to a person's face.

In Step S140 of FIG. 4, the face area detecting module 400 detects a face area by using the detection window that is in correspondence with the detection window size within the search range SRW. In FIG. 7, three detection windows DW1, DW2, and DW3 having different sizes are used. In FIG. 7, a target image IMG that is the same as that of FIG. 6 is shown. The face area detecting module 400 detects a face area FA that represents a face of a person P1. However, an area that represents the face of a person P2 within the poster PS is not detected as a face area. The reason is that the actual size of the face of the person P2 is sufficiently larger than the size of a real person's face.

As described above, according to this embodiment, the search range SRW of the size of the detection window DW is determined based on the predetermined range of the actual size in accordance with the size relationship. Accordingly, the actual size that can be acquired from the size within the search range SRW in accordance with the size relationship is within the predetermined range. Here, the size (for example, the height) of the detection window DW represents the size of a rectangle that includes two eyes, a nose, and a mouth. In other words, the size of the detection window DW represents the size in the target image which reflects the size of a face. Accordingly, detection of an area representing an excessively large face (for example, an area that represents a face copied in a poster) or an excessively small face (for example, an area that represents the face of a doll) as a face area is suppressed. As a result, the face is detected in consideration of the type of subject. In particular, according to this embodiment, the face area detecting module 400 does not detect any face area in accordance with a detection window DW having a size beyond the search range SRW. Accordingly, the face area detecting module 400 can perform detection of the face area at a high speed. The face area detecting module 400 may determine the search range SRW based on various values relating to the size of the detection window DW, instead of the size of the detection window DW.

### Third Embodiment

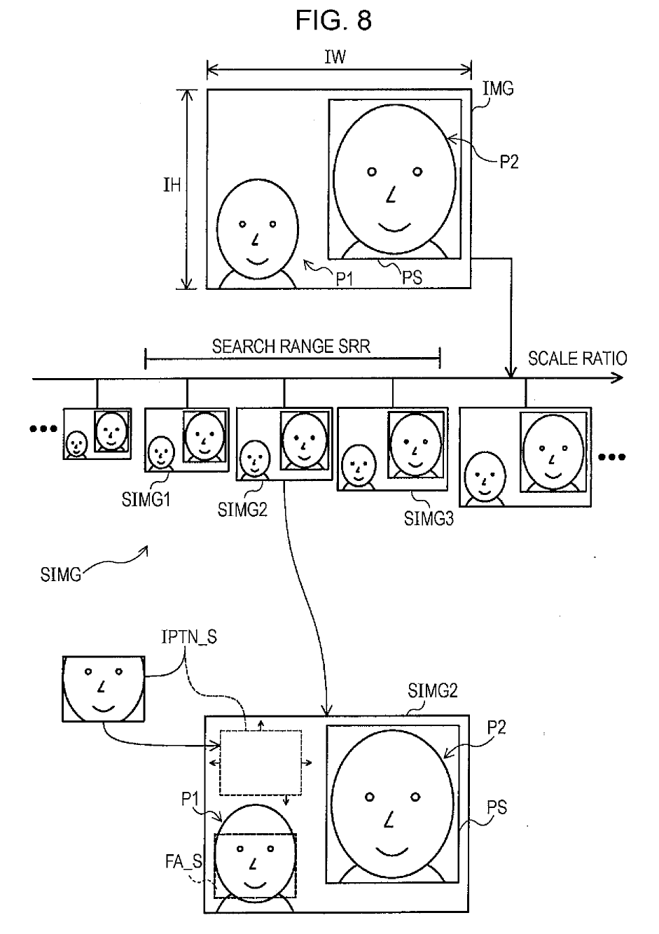

FIG. 8 is a schematic diagram of a process of searching a face area according to a third embodiment of the invention. The first embodiment of FIG. 6 and the third embodiment differ in that, in the third embodiment, a target image IMG is scaled instead of scaling the image pattern IPTN. The sequence of the printing process is the same as that of FIG. 4. However, the two Steps S130 and S140 are different from those of the first embodiment. The other steps are the same as those of the first embodiment. In addition, the configuration of a printer is the same as that of the printer 100 of the first embodiment.

According to the third embodiment, a face area detecting module 400 (FIG. 2) detects a face area by using an image pattern IPTN_S of a predetermined size. In this embodiment, the shape of the image pattern IPTN_S is rectangular, and the size (for example, the numbers of pixels in the vertical and horizontal directions) of the image pattern IPTN_S is fixed.

The face area detecting module 400 generates a scaled image SIMG by scaling (enlarging or reducing) the target image IMG. In this embodiment, this scaling process is performed without changing the aspect ratio. Then, the face area detecting module 400 detects an area of the scaled image SIMG that matches the image pattern IPTN_S. Various known methods may be employed as a scaling method. For example, the target image IMG may be reduced by thinning out pixels. In addition, pixel values of an image after being reduced may be determined based on an interpolation process (for example, linear interpolation). Similarly, pixel values of an image after being enlarged may be determined based on an interpolation process.

Here, the ratio of the size of the scaled image SIMG to the size of the target image IMG is referred to as a scaling ratio (as the size, for example, the number of pixels in the height direction or the number of pixels in the width direction may be employed). When the scaling ratio is large, the ratio of the size of the image pattern IPTN_S to the size of the scaled image SIMG is small. Accordingly, in such a case, a face having a small size in the target image IMG can be detected. To the contrary, when the scaling ratio is small, the ratio of the size of the image pattern IPTN_S to the size of the scaled image SIMG is large. Accordingly, in such a case, a face having a large size in the target image IMG can be detected. The scaling ratio may be smaller than one or larger than one.

As described above, the scaling ratio has a correlation with the size of the face area that is detected from the target image IMG (there is a negative correlation). The size of the detected face area in the target image IMG is the same as a size acquired from dividing the size of the image pattern IPTN_S by the scaling ratio. On the other hand, as described above, an appropriate range of the face area in the target image IMG is determined based on a predetermined range (for example, 5 cm to 50 cm) of the actual size and the size relationship (Expression 3: FIG. 5).

In Step S130 of FIG. 4, the face area detecting module 400 determines an appropriate range (the search range SRR) of the scaling ratio based on the size (for example, the number of pixels in the vertical direction) of the image pattern IPTN_S, the predetermined range (for example, 5 cm to 50 cm) of the actual size, and the size relationship. Here, the search range SRR is determined such that the actual size of the detected face area corresponding to the size in the target image IMG is within a predetermined range. In other words, the search range SRR is determined such that the size of the detected face area in the target image IMG is within the range of the size in the target image IMG that is acquired from the predetermined range of the actual size based on the size relationship. For example, a maximum value of the scaling ratio is set as a value acquired from dividing the size (for example, the height) of the image pattern IPTN_S by the size in the target image that can be acquired from a minimum value (for example, 5 cm) of the predetermined range based on the size relationship. In addition, the minimum value of the scaling ratio is set as a value that can be acquired from dividing the size of the image pattern IPTN_S by the size in the target image that can be acquired from the maximum value (for example, 50 cm) of the predetermined range based on the size relationship.

In Step S140 of FIG. 4, the face area detecting module 400 detects a face area by using the scaled image SIMG that is in correspondence with the scaling ratio within the search range SRR. In FIG. 8, three scaled images SIMG1, SIMG2, and SIMG3 having different scaling ratios are used. The interval of the used scaling ratios is preferably experimentally determined in advance to appropriately detect faces of persons that have various sizes.

In a lower part of FIG. 8, a second scaled image SIMG2 is shown that is generated from the same target image IMG as that of FIG. 6. The face area detecting module 400 detects a face area FA_S representing the face of the person Pi from this second scaled image SIMG2. However, an area that represents the face of a person P2 within the poster PS is not detected as a face area. The reason is because the actual size of the face of the person P2 is sufficiently larger than the actual size of a person's face.

As described above, according to this embodiment, the search range SRR of the scaling ratio is determined based on the predetermined range of the actual size and the size of the image pattern IPTN_S in accordance with the size relationship. Here, the search range SRR is determined such that the actual size of the detected face area is within a predetermined range. Accordingly, detection of an area representing an excessively large face or an excessively small face as a face area is suppressed. As a result, the face is detected in consideration of the type of subject. In particular, according to this embodiment, the face area detecting module 400 does not detect any face area in accordance with a scaling ratio beyond the search range SRR. Accordingly, the face area detecting module 400 can perform detection of the face area at a high speed.

### Fourth Embodiment

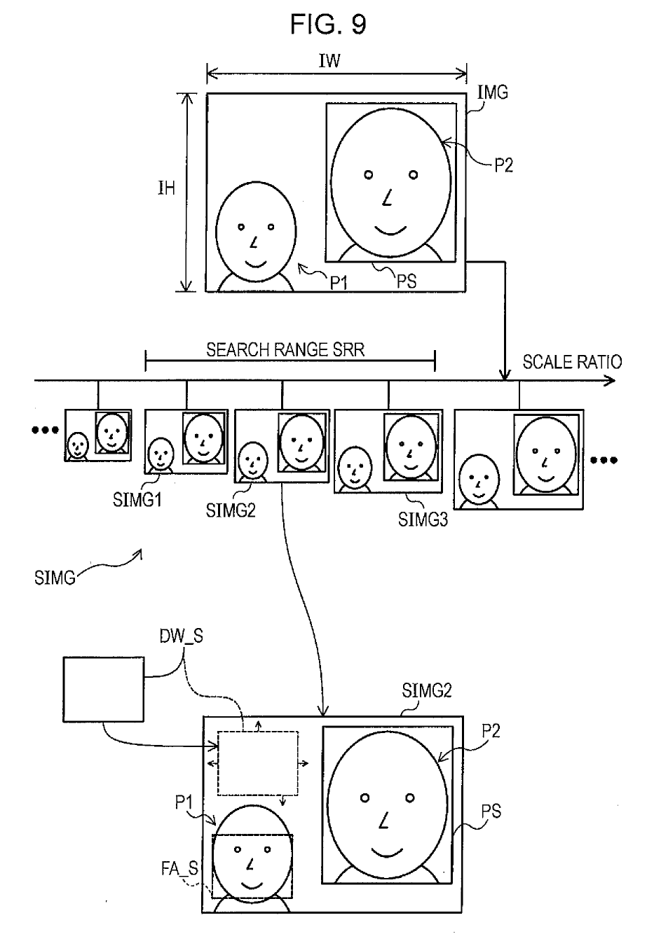

FIG. 9 is a schematic diagram of a process of searching a face area according to a fourth embodiment of the invention. The third embodiment of FIG. 8 and the fourth embodiment differ in that, in the fourth embodiment, a detection window DW_S of a predetermined size is used instead of the image pattern IPTN_S. In the fourth embodiment, the shape of the search window DW_S is a rectangle, and the size (for example, the numbers of pixels in the vertical and horizontal directions) of the detection window DW_S is fixed. The sequence of the printing process is the same as that of FIG. 4. However, the two Steps S130 and S140 are different from those of the first embodiment. The other steps are the same as those of the first embodiment. In addition, the configuration of a printer is the same as that of the printer 100 of the first embodiment.

According to this embodiment, a face area detecting module 400 (FIG. 2) detects a face area by using a learning-completed neural network, in the same manner as in the embodiment of FIG. 7. In addition, the face area detecting module 400 substantially adjusts the size of the search window in the target image IMG by adjusting the scaling ratio in the same manner as in the embodiment of FIG. 8. Accordingly, detection of an area representing an excessively large face (for example, an area that represents a face copied in a poster) or an excessively small face (for example, an area that represents the face of a doll) as a face area is suppressed. As a result, the face is detected in consideration of the type of subject. In particular, according to this embodiment, the face area detecting module 400 does not detect any face area in accordance with a scaling ratio beyond the search range SRR. Accordingly, the face area detecting module 400 can perform detection of the face area at a high speed.

### Fifth Embodiment

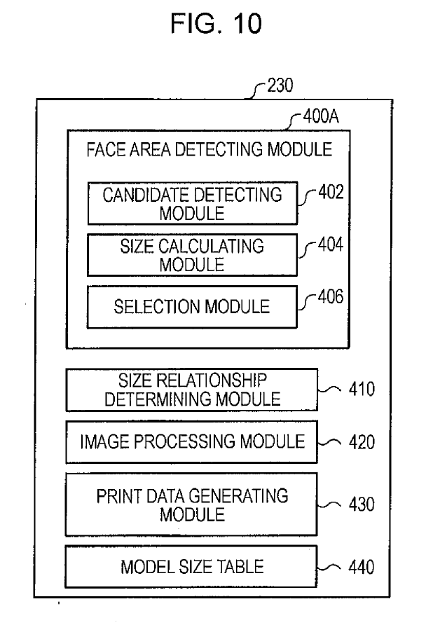

FIG. 10 is an explanatory diagram showing modules and data that are stored in a ROM 230 according to a fifth embodiment of the invention. The embodiment of FIG. 2 and the fifth embodiment differ in that, in the fifth embodiment, a face area detecting module 400A is stored, instead of the face area detecting module 400. The face area detecting module 400A includes a candidate detecting module 402, a size calculating module 404, and a selection module 406. The configuration of a printer is the same as that of the printer 100 of the first embodiment.

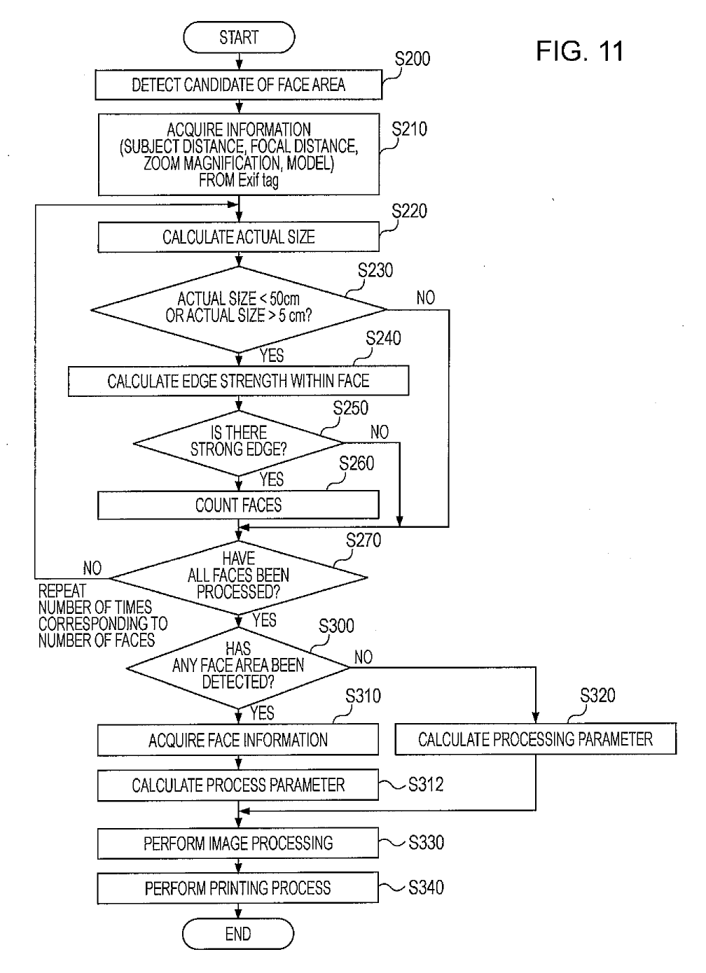

FIG. 11 is a flowchart of the sequence of a printing process. In Step S200, the candidate detecting module 402 (FIG. 10) detects candidates of a face area from a target image by analyzing data of the target image. The face area represents an area of the target image that includes at least a part of a face. The candidate detecting module 402 detects candidates of a face area regardless of the sizes in the target image.

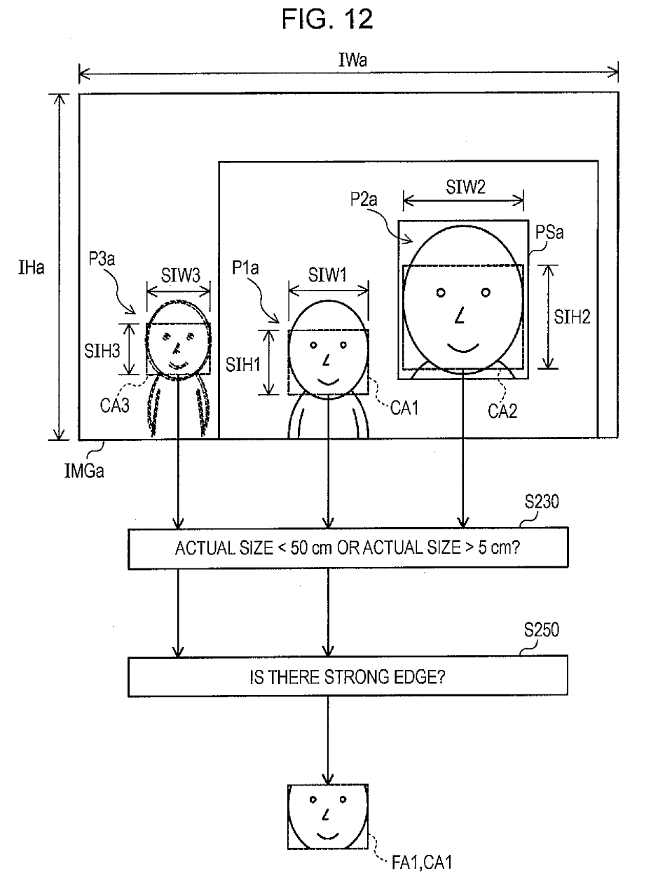

FIG. 12 is a schematic diagram showing the result of the detection of candidates of a face area. In a target image IMGa of FIG. 12, a person P1a, a poster PSa, and a person P3a that is located away from the poster PSa are copied. The poster PSa represents a person P2a. Here, it is assumed that the actual size of the face of the person P2a shown in the poster PSa is sufficiently larger than the size of a real person's face. In addition, the person P3a is copied blurrily. The reason is because the person P1a is in focus but the person P3a is out of focus.

Three face area candidates CA1, CA2, and CA3 are detected from the target image IMGa. As shown in FIG. 12, a rectangular area that includes images of two eyes, a nose, and a mouth is detected as a candidate of a face area. When a face is copied to be small, a small face area is detected. On the other hand, when the face is copied to be larger a large face area is detected. As described above, the size of the face area (candidate) is related to the size of the face in the target image. In addition, the aspect ratio of the face area may be changed in accordance with the face included the target image. Alternatively, the aspect ratio may be fixed. Any area that includes an image of at least a part of a face may be used as the detected face area. For example, the face area may include an entire face.

According to this embodiment, the shape of the target image IMGa is rectangular, as in the above-described embodiments. The image height IHa and the image width IWa represent the height (the length of a shorter side) of the target image IMGa and the width (the length of a longer side) of the target image (in units of the numbers of pixels), respectively. The height SIH1 of the face area and the width SIW1 of the face area represent the height and the width of the first face area candidate CA1 (in units of the numbers of pixels), respectively. Similarly, the height SIH2 of the face area and the width SIW2 of the face area represent the height and the width of the second face area candidate CA2, respectively. In addition, the height SIH3 of the face area and the width SIW3 of the face area represent the height and the width of the third face area candidate CA3, respectively.

Various known methods can be used as a detection method for a face area (candidate) using the candidate detecting module 402. According to this embodiment, a face area is detected by performing a pattern matching process by using template images of an eye and template images of a mouth which are organs of a face. Various methods, such as pattern matching using templates, can be used as the detection method for a face area (for example, see JP-A-2004-318204).

In Step S210 of FIG. 11, as in Step S110 of FIG. 4, the size relationship determining module 410 (FIG. 10) acquires related information from a target image file. Then, the size relationship determining module 410 determines (sets) the size relationship in accordance with Equation 3 described with reference to FIG. 5.

In Step S220, the size calculating module 404 calculates an actual size corresponding to the face area candidate in accordance with the size relationship. In this embodiment, the size calculating module 404 calculates the actual size corresponding to the height of the face area candidate. As described above, the size of the face area candidate is related to the size of the face in the target image. Accordingly, the calculated actual size has a positive correlation with the actual size (for example, a length from the top of a head to a front end of a chin) of a face of a subject. In other words, as the calculated actual size is increased, the actual size of the face of the subject increases. The actual size corresponds to “a size reference value” of the claims.

In Step S230, the selection module 406 (FIG. 10) determines whether the face area candidate satisfies the following Condition C1:

Condition C1,

where the actual size is smaller than 50 cm, and the actual size is larger than 5 cm.

A case where the face area candidate satisfies condition C1 indicates that there is a high possibility that the face represented by the face area candidate is a real person's face. The range that is appropriate to the face of a person may be other than the range of 5 cm to 50 cm and is preferably determined experimentally in advance.

When the face area candidate satisfies condition C1, the selection module 406 analyzes the face area candidate and calculates the edge strength within the face in Step S240. According to this embodiment, the selection module 406 calculates the edge strength of each pixel that represents the face. Various values may be used as the edge strength. For example, an absolute value of the result that is obtained from applying a Laplacian filter to the luminance values of each pixel may be used as the edge strength. Various methods of determining the pixels representing a face may be used. For example, skin-colored pixels within the face area candidate may be selected as pixels that represent a face. Here, the skin-colored pixel indicates a pixel that represents a color in a predetermined skin-color range. In addition to the skin-colored pixels within the face area candidate, skin-colored pixels in the peripheral part of the face area candidate may be selected.

In Step S250, the size calculating module 404 determines whether the face area candidate satisfies the following condition C2:

Condition C2,

where the maximum value of the edge strength is larger than a predetermined threshold value.

As the sharpness of a face becomes stronger, the maximal value of the edge strength increases. Accordingly, the maximal value of the edge strength indicates the degree of sharpness of a face. As described above, condition C2 represents a case where the degree of sharpness of a face is higher than the threshold value. When the face area candidate satisfies condition C2, there is a high possibility that the face represented by the face area candidate is in focus at a time of photographing the target image. On the other hand, when condition C2 is not satisfied, there are many cases that the face represented by the face area candidate is out of focus. In such a case, there is a high possibility that the subject distance SD and the lens focal distance FL which are shown in FIG. 5 are not appropriate to each other.

When the face area candidate satisfies condition C2, the selection module 406 (FIG. 10) selects the face area candidate as a face area (Step S260). When either one of conditions C1 and C2 is not satisfied, the selection module 406 excludes the face area candidate from the face area.

The face area detecting module 400A (FIG. 10) repeats Steps S220-S260 of FIG. 11 for each detected face area candidate. When the processes for all the face area candidates are completed (Step S270: Yes), the process proceeds to Step S300. Processes subsequent to Step S300 are the same as the processes subsequent to Step S300 of FIG. 4.

In FIG. 12, the result of detection of the face area in the above-described processes is shown. The actual size of the second face area candidate CA2 is larger than 50 cm, and thus the second face area candidate CA2 is excluded from the face area (Step S230). In addition, since the face of the first image area candidate CA1 is blurred, the first face area candidate CA1 is excluded from the face area (Step S250). Then, the first face area candidate CA1 is selected as the face area.

As described above, according to this embodiment, when the size of a face area candidate in the target image is within the range of the size in the target image which can be acquired from a predetermined range of the actual size in accordance with the size relationship, the face area candidate is selected as the face area. In other words, when the actual size corresponding to the size of a face area candidate in the target image is within the predetermined range, the face area candidate is selected as the face area. As a result, detection of an area representing an excessively small face or an excessively large face as the face area is suppressed, and a face is detected in consideration of the type of subject.

When the degree of sharpness of a face is higher than the threshold value, the face area candidate is selected as a face area. Accordingly, an area representing a sharp face can be detected as a face area. In this way, a sharp face that easily attracts attention of an observer of the target image is detected as a face area. In addition, selection of an out-of-focus face as a face area is suppressed. Moreover, selection of a face area based on the actual size that is calculated based on the inappropriate subject distance SD and the lend focal distance FL is suppressed.

### Sixth Embodiment

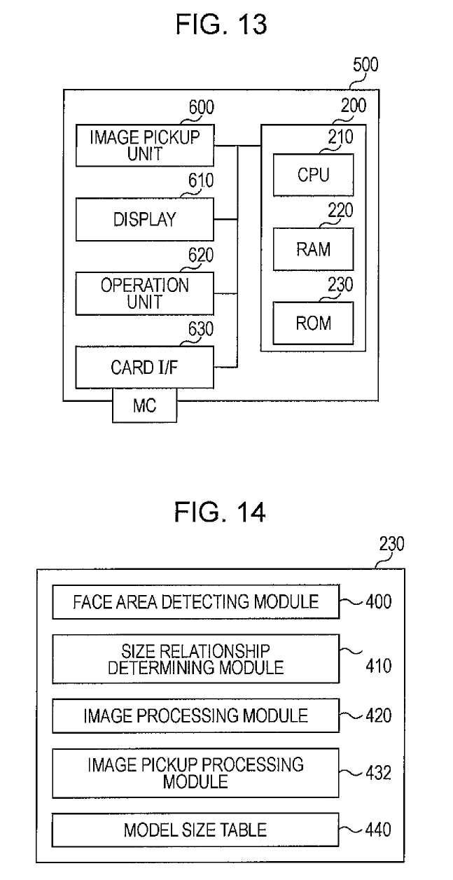

FIG. 13 is a block diagram of a digital still camera 500 according to a sixth embodiment of the invention. Digital still camera 500 includes a control unit 200, an image pickup unit 600, a display 610, an operation unit 620, and a card I/F 630.

The image pickup unit 600 generates image data by performing an image pickup operation. The image pickup unit 600 includes a lens system, an image pickup element, and an image data generating part. The image pickup unit 600 can sequentially generate the image data by repeating the image pickup operation.

The display 610, the operation unit 620, and the card I/F 630 are the same as the display 310, the operation panel 320, and the card I/F 330 that are shown in FIG. 1.

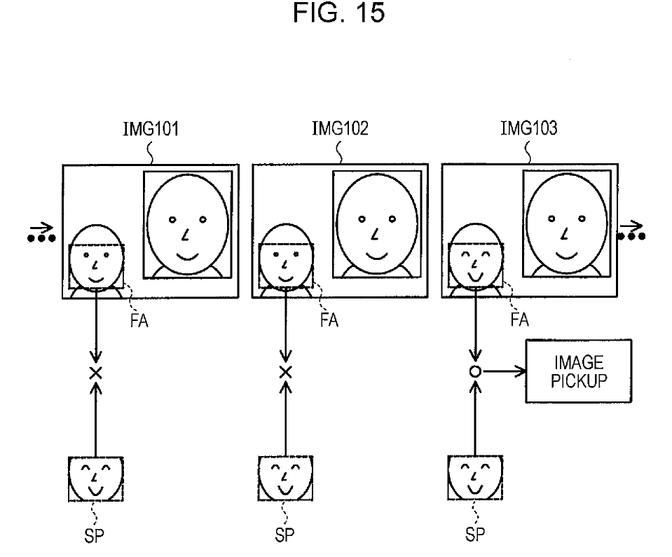

The hardware configuration of the control unit 200 is the same as that of the embodiment in FIG. 1. FIG. 14 is a block diagram showing modules and data that are stored in a ROM 230 (FIG. 13). The embodiment of FIG. 2 and the sixth embodiment differ in that, in the sixth embodiment, an image pickup processing module 432 is disposed instead of the print data generating module 430.

The image pickup processing module 432 (FIG. 14) of the control unit 200 (FIG. 13) controls the image pickup unit 600 to start repetition of an image pickup operation in response to a user's direction. This repetition of the image pickup operation is performed for determining whether an image pattern represented by a face of the subject matches a predetermined image pattern. The control unit 200 sequentially detects a face area for each image data that is sequentially generated by the image pickup unit 600. According to this embodiment, the face area detecting module 400 and the size relationship determining module 410 detect a face area in the same sequence as in Steps S110-S140 of FIG. 4. Any of the processes of FIGS. 6-9 may be employed as a detailed process. The size relationship determining module 410 acquires a subject distance, a lens focal distance, and digital zoom magnification from the image pickup unit 600. The size relationship determining module 410 uses predetermined values as the size (for example, a height SH) of an image pickup element and the size (for example, an image height IH) of the image data. As described above, the size relationship determining module 410 can determine the size relationship without using the image data.

The image pickup processing module 432 (FIG. 14) sequentially determines whether an image pattern represented by a face area matches a predetermined image pattern. FIG. 15 is a schematic diagram representing the determination process of the image data. In FIG. 15, parts of a plurality of images that are sequentially generated by the image pickup unit 600 are shown (IMG101, IMG102, and IMG103). From these images, face areas FA are detected. The image pickup processing module 432 sequentially determines whether the image patterns represented by the face areas FA match a predetermined image pattern (referred to as a “reference pattern SP”). In FIG. 15, the patterns are not matched in the first two images IMG101 and IMG102. However, in the third image IMG103, the patterns are matched. A known pattern matching method can be used as a method of determining whether two image patterns are matched. For example, the determining process may be performed by appropriately scaling the size of the reference pattern SP.

As the pattern of the face area FA matches the reference pattern SP, the image pickup processing module 432 outputs an image pickup direction to the image pickup unit 600. The image pickup unit 600 generates image data by performing an image pickup operation in accordance with the direction. By performing this image pickup operation, image data representing an image including a face area that matches the reference pattern SP is generated. According to this embodiment, the reference pattern SP represents a smiling face. Accordingly, as the face of the subject represented by the face area is changed to a smiling face, an image representing the smiling face is automatically picked up. As described above, the image pickup processing module 432 picks up the image including the face area that matches the reference pattern SP. The reference pattern SP is not limited to the pattern representing the smiling face, and any arbitrary pattern may be used as the reference pattern SP. Hereinafter, the image pickup operation performed in accordance with a direction of the image pickup processing module 432 is referred to as “pattern image pickup”. In addition, the image data that is generated by the pattern image pickup is referred to as “pattern image pickup data”.

The image pickup unit 600 (FIG. 13) supplies the pattern image pickup data to the control unit 200. The image pickup processing module 432 (FIG. 14) stores an image file, in which the pattern image pickup data is stored, in a memory card MC. In this embodiment, the memory card MC is a non-volatile memory. Accordingly, a user can use the pattern image pickup data in an easy manner. In addition, the memory card MC is a memory that can be detachably attached. Accordingly, a user can carry the pattern image pickup data in a simple manner.

Regarding settings of the operations of the image pickup unit 600, the setting for the pattern image pickup may be different from that for the sequential image pickup operation. For example, the image pickup unit 600 may be configured to generate pixel data having a small number of pixels for the sequential image pickup operation and pixel data having a large number of pixels for the pattern image pickup. Generally, a setting in which a processing load is low is preferably used for the sequential image pickup operation. In such a case, the speed of repetition of the image pickup operation can be increased. On the other hand, a setting for generating image data of a high definition is preferably used in the pattern image pickup.

The method of detecting a face area is not limited to the sequence of FIG. 4. A method according to Steps S200-S270 of FIG. 11, for example, may be used.

The image pickup processing module 432 (FIG. 14) according to this embodiment corresponds to “a process performing unit” of the claims. A process that is performed for a case where the image pattern of the face area matches the reference pattern SP is not limited to an image pickup process or generation of an image file, and other processes may be used. For example, a process of adjusting the skin color within the face area may be performed. In addition, a printer may be connected to the digital still camera 500 through a communication path. In such a case, a process of printing the target image by using the printer may be used.

The control unit 200 (FIG. 13) may perform a process that is the same as in the embodiments of FIG. 4 or 11 for the image data generated by the image pickup operation, regardless of match of the image pattern of the face area to the reference pattern SP. For example, the control unit 200 directs the image pickup unit 600 to perform an image pickup operation in accordance with a user's direction. The image pick unit 600 generates the image data by performing an image pickup operation and supplies the generated image data to the control unit 200. The control unit 200 performs image processing by using the received image data and stores the image file in which the image data, for which the image processing is completed, is stored in the memory (for example, the memory card MC).

The process according to the embodiments of FIGS. 4 and 11 may be used as the image processing by using the control unit 200. However, according to this embodiment, the image processing module 420 (FIG. 14) stores the image file in the memory card MC, instead of performing the printing operation in Step S340.

### MODIFIED EXAMPLES

The constituent elements of the above-described embodiments that are not included in the independent claims are additional elements and may be omitted appropriately. The invention is not limited to the above-described embodiments or examples and may be performed in various forms without departing from the scope of the invention. For example, the following changes in form can be made.

### Modified Example 1

In the above-described embodiments, as the method of detecting a face area (or a candidate area thereof) by using an image pattern, various methods in which a predetermined image pattern representing at least a part of a face is used may be used. For example, one face area may be detected by using a plurality of image patterns that represent different parts within a face (for example, both an image pattern representing eyes and a nose and an image pattern representing a nose and a mouth may be used). In addition, the shape of the image pattern is not limited to a rectangular shape, and other shapes may be used.

In the above-described embodiments, the shape of the detection window is not limited to a rectangular shape, and other shapes may be used.

In the above-described embodiments, the method of detecting a face area (or a candidate area thereof) that includes at least a partial image of a face is not limited to a method using pattern matching or a neural network. Other methods may be used such as, for example, boosting (for example, AdaBoost) or a support vector machine. In addition, a face area may be detected by combining the above-described methods. For example, the methods of FIG. 6 and FIG. 7 may be combined. In such a case, a common face area that is detected by using both the methods is preferably used as a finally detected face area. Similarly, the methods of FIGS. 8 and 9 may be combined. In addition, an arbitrary combination of the methods of FIGS. 6-9 may be used. In any case, a final detection result may be determined by appropriately combining the detection results of the plurality of methods by using a logical sum or product.

In the above-described embodiments, as the predetermined range of the actual size, a range of a relatively small size may be used. In such a case, the face of a child can be detected. In addition, as this range, a range of a relatively large size may be used. In such a case, the face of an adult can be detected. The range of the actual size is not limited to a range that is appropriate to a real person's face, and a range appropriate to another subject (for example, a doll or a poster) that is similar to a person's face may be used.

In the above-described embodiments, the method of detecting a face area is not limited to a method of detecting a face area by using a predetermined range of the actual size. Various methods such as detecting a face area by using the size relationship may be used. For example, the range of the actual size may be determined by a user.

### Modified Example 2

In the above-described embodiments, various values related with the actual size of a face may be used as the size reference value. For example, the size reference value may be in correspondence with various sizes that reflect the size of a face. In other words, the size reference value may be in correspondence with various sizes that are related with a face. For example, as in the above-described embodiments, the size reference value may be in correspondence with the size of a face area. Here, the length of the image pickup element IS in the width direction (corresponding to a longer side of the light receiving area) may be used. In addition, the size reference value may be in correspondence with a distance between two positions acquired with reference to positions of organs within a face. For example, the size reference value may be in correspondence with a distance between a center position of two eyes and a mouth. In any case, the size calculating module 404 (FIG. 10) can calculate the size reference value based on various sizes (the sizes in the target image) that reflect the size of a face. As an example, it is assumed that the size reference value corresponds to the distance between the center position of the two eyes and the mouth. In such a case, the size calculating module 404 preferably calculates the size reference value based on the distance (the number of pixels) between the center position of two eyes and the mouth. Here, the size calculating module 404 preferably uses the eyes and the mouth that are detected by the candidate detecting module 402. In addition, the size reference value is not limited to distance (length) and may be in correspondence with various sizes such as area.

As described above, various sizes that are related with the size of a face may be used as the size in the target image that reflects the size of a face.

### Modified Example 3

In the above-described embodiments, any arbitrary relationship that represents relationship between the size in the target image and the actual size may be used as the size relationship. For example, the size is not limited to distance (length), and area may be used as the size.

In addition, in the above-described embodiments, the information used for determining the size relationship preferably includes the following information.

1) image pickup distance information that is related with a distance from the image pickup device to a person at a time when the target image is picked up;

2) focal distance information that is related with a lens focal distance of the image pickup device at a time when the image pickup operation is performed; and

3) image pickup element information that is related with the size of a part of the light receiving area of the image pickup element of the image pickup device in which the target image is generated.

In the embodiment of FIG. 5, digital zoom magnification DZR is used, in addition to the above-described information. However, when image data that is generated by an image pickup device that does not have a digital zoom function is used, the size relationship determining module 410 (FIGS. 2 and 10) preferably determines the size relationship without using digital zoom magnification DZR.

A combination of a maker name and a model name may be used as the image pickup element information. There is a type of image pickup device that generates image data by cropping pixels located in the peripheral part of an image pickup element (entire light receiving area) in accordance with a user's direction. When such image data is used, the size relationship determining module 410 preferably uses the size of the light receiving area occupied by the remaining pixels after the crop process (that is, the size of a part of the light receiving area in which the target image is formed), instead of the size of the image pickup element (more particularly, the entire light receiving area). The size relationship determining module 410 can calculate the size of the part based on a ratio of the size of image data with crop to the size (for example, the height or the width) of image data without any crop and the size of the entire light receiving area (this information is preferably determined by the image pickup element information). In addition, when the target image (target image data) is generated without any crop, the entire light receiving area of the image pickup element corresponds to the part in which the target image is generated. In any case, the image pickup element information preferably defines the length of at least one side between the longer side and the shorter side of the light receiving area. When the length of one side is determined, the length of the other side can be determined based on the aspect ratio of the target image.

There is a type of image pickup device in which the range of the subject distance, instead of the subject distance SD, is recorded in the image file. When such an image file is used, the size relationship determining module 410 preferably uses the range of the subject distance instead of the subject distance SD. The range of the subject distance, for example, represents three levels of a “macro”, a “close view”, and a “distant view”. In such a case, representative distances of three levels are preferably attached in advance and the size relationship determining module 410 determines the size relationship by using the representative distances.

Various methods in which related information related with the target image is used may generally be used to determine the size relationship,. Here, any arbitrary information that can be used for determining the correspondence relationship between the size (for example, the length in a unit of the number of pixels) in the target image and the actual size may be used as the relation information. For example, the image pickup device may output the ratio of the actual length (for example, in centimeter unit) to the length (the number of pixels) in the image. When such a ratio can be used, the size relationship determining module 410 preferably determines the size relationship by using the ratio.

### Modified Example 4

In the face detecting process of FIG. 11, the degree of sharpness of a face that is used in Steps S240 and S250 is not limited to the maximum value of the edge strength within the face. Thus, various values representing sharpness of a face can be used. For example, an integrated value that can be acquired by integrating the edge strengths of a plurality of pixels that represents a face can be used. As the integrated value, for example, various values that are represented by a function of the edge strengths of each pixel, such as an average value, a maximum value, a mode value, or a median may be used. In addition, at least a part of a plurality of pixels that represents a face is preferably used for determining the degree of the sharpness.

In addition, in the face detecting process of FIG. 11, Steps S240 and S250 may be omitted.

### Modified Example 5

In the above-described embodiments, any arbitrary use of the result of detection of the face area can be applied. For example, the image processing module 420 (FIGS. 2 and 10) may perform a deformation process of thinning the width of the detected face. In addition, the image processing module 420 may select the image, of which a face area is detected, from among a plurality of images. The selected image may be used arbitrarily. For example, the selected image may be used for a printing process or copied to a predetermined folder.

### Modified Example 6

In the above-described embodiments, the image processing apparatus that detects a face area is not limited to the printer 100 (FIG. 1) or the digital still camera 500 (FIG. 13). Any arbitrary image processing apparatus may be used. For example, a general-purpose computer may be configured to detect a face area from the target image.

In addition, the image processing apparatus is not limited to the configurations shown in FIGS. 1 and 13. Generally, any arbitrary configuration in which the face area detecting module 400 (or the face area detecting module 400A) and the size relationship determining module 410 are included may be used. For example, the image processing apparatus may acquire the target image data from an image generating device (for example, an image pickup device such as a digital still camera) through a communication cable or a network. In addition, the image processing apparatus may have a rewritable non-volatile memory in which the model size table 440 (FIG. 2) is stored. The size relationship determining module 410 may update the model size table 440. For example, an update according to a user's direction and an update of a new model size table 440 that is downloaded through a network may be employed.

### Modified Example 7

In the above-described embodiments, the image data to be processed is not limited to image data that is generated by a digital still camera (still screen image data). Image data that is generated by other image generating devices, such as a digital video camera (moving picture data), can be used. In such a case, the modules 400 and 410 of FIG. 2 preferably perform determination on the size relationship and detection of a face area by using at least a part of a plurality of frame images that is included in a moving picture. The image processing module 420 may select a moving picture that includes a frame image, in which a face area is detected, from among a plurality of moving pictures. In such a case, a user can use a moving picture in which a person's face is copied in a simple manner by using the selected moving picture. In addition, selection of a moving picture that includes a target image (frame image) is also the process (a process on the target image) for the target image.

### Modified Example 8

In the above-described embodiments, a part of the configuration implemented by hardware may be changed to be implemented by software, or a part or the whole of the configuration that is implemented by software may be changed to be implemented by hardware. For example, the function of the face area detecting module 400 of FIG. 1 may be implemented by using a hardware circuit having a logic circuit.

In addition, when a part or the whole of the function of an embodiment of the invention is implemented by software, the software may be provided in a form in which the software is stored in a computer-readable recording medium. The “computer-readable recording medium” according to an embodiment of the invention is not limited to a portable recording medium such as a flexible disk or a CD-ROM and includes an internal storage device of a computer such as various types of RAMs and ROMs and an external storage device, which is fixed to a computer, such as a hard disk.

What is claimed is:

1. An image processing apparatus comprising:
a size relationship determining unit that determines a size relationship between a size in a target image and an actual size; and
a face area detecting unit that detects a face area of the target image that includes at least a partial image of a face of a person,
wherein the face area detecting unit determines a range of a control parameter correlated with the size in the target image from a predetermined range of the actual size in accordance with the size relationship, and detects the face area in accordance with the control parameter within the determined range.

2. The image processing apparatus according to claim 1, wherein the face area detecting unit shows at least a part of the face and detects the face area by using at least one of an image pattern of a size that is in correspondence with the control parameter and a detection window, which is used to select a detection target area from the target image, of a size that is in correspondence with the control parameter.

3. The image processing apparatus according to claim 1,
wherein the control parameter represents a scaling ratio for scaling the target image, and
wherein the face area detecting unit generates a scaled image by scaling the target image in accordance with the scaling ratio and detects the face area by using the scaled image and at least one of an image pattern of a predetermined size representing at least a part of the face and a detection window of a predetermined size being used to select a detection target area from the scaled image.

4. The image processing apparatus according to claim 1, further comprising:
an image pickup unit that generates image data by performing an image pickup operation; and
a process performing unit that performs a determination process in accordance with a match of an image pattern represented by the face area with a predetermined pattern,
wherein the image pickup unit sequentially generates the image data by repeating the image pickup operation, and
wherein the size relationship determining unit and the face area detecting unit sequentially determine the size relationship and detect the face area by using each image represented by the image data, which is sequentially generated.

5. The image processing apparatus according to claim 4, wherein the determination process includes a process of performing an image pickup operation on an image including the face area that matches the predetermined pattern.

6. The image processing apparatus according to claim 1,
wherein the target image is an image that is generated by an image pickup device,
wherein the size relationship determining unit determines the size relationship by using related information that is related with the target image, and
wherein the related information includes:
image pickup distance information that is related with a distance from the image pickup device to the person upon performing the image pickup operation on the target image;
focal distance information that is related with a lens focal distance of the image pickup device upon performing the image pickup operation; and
image pickup element information that is related with a size of a part of a light receiving area of the image pickup element of the image pickup device in which the target image is generated.

7. A printer comprising:
a size relationship determining unit that determines a size relationship between a size in a target image and an actual size;
a face area detecting unit that detects a face area of the target image that includes at least a partial image of a face of a person;
an image processing unit that performs a determination process on the target image in accordance with the detected face area; and
a printing unit that prints the target image processed by the image processing unit,
wherein the face area detecting unit determines a range of a control parameter correlated with the size in the target image from a predetermined range of the actual size in accordance with the size relationship, and detects the face area in accordance with the control parameter within the determined range.

8. An image processing method comprising;
determining a size relationship between a size in a target image and an actual size; and
detecting a face area of the target image that includes at least a partial image of a face of a person,
wherein the detecting of the face area includes determining a range of a control parameter correlated with the size in the target image from a predetermined range of the actual size in accordance with the size relationship and detecting the face area in accordance with the control parameter within the determined range.

9. A computer program embodied in a computer-readable medium for image processing that causes a computer to execute:
a size relationship determining function of determining a size relationship between a size in a target image and an actual size; and
a face area detecting function of detecting a face area of the target image that includes at least a partial image of a face of a person,
wherein the face area detecting function includes a function of determining a range of a control parameter correlated with the size in the target image from a predetermined range of the actual size in accordance with the size relationship and a function of detecting the face area in accordance with the control parameter within the determined range.
